(19) United States
(12) Patent Application Publication
(10) Pub. No.: US 2015/0302333 A1
(43) Pub. Date: Oct. 22, 2015

(54) PROVIDING AIR TRANSPORTATION SERVICES USING INTEGRATED PLATFORM

(71) Applicant: Profusion Corp., Road Town (VG)

(72) Inventor: Harold Roy Miller, Toronto (CA)

(21) Appl. No.: 14/692,319

(22) Filed: Apr. 21, 2015

Related U.S. Application Data
(60) Provisional application No. 61/982,215, filed on Apr. 21, 2014.

(51) Int. Cl. G06Q 10/06; G06Q 10/10; G06Q 30/02

(52) U.S. Cl. CPC G06Q 10/06315; G06Q 30/0201; G06Q 10/109; G06Q 10/067; G06Q 50/30

(57) ABSTRACT

Methods and systems for providing air transportation services using an integrated platform are described herein. The system comprises an irregular operations (IROPs) platform configured to manage operations associated with IROPs, an operations platform configured to manage operations associated with normal operations conditions, a planning platform configured to generate schedules, maintenance schedules, crew rosters, and financial models; a data and cloud services platform configured to provide market data, and a professional services platform configured to provide management and consulting services. All the platforms are integrated with each other and into an airline infrastructure.

### CROSS-REFERENCE TO RELATED APPLICATIONS

The present utility patent application is related to and claims priority benefit of the U.S. provisional application No. 61/982,215, filed on Apr. 21, 2014 under 35 U.S.C. 119(e). The contents of the provisional application are incorporated herein by reference for all purposes to the extent that such subject matter is not inconsistent herewith or limiting hereof.

### TECHNICAL FIELD

The present disclosure relates generally to providing air transportation services and, more particularly, to providing air transportation services using an integrated platform.

### BACKGROUND

An airline needs a multitude of systems to plan and operate an airline. These systems because of their complexity and available technology have been organized into silos within the airline. A complex sequence of methods involving the systems and jurisdictional areas within the airline has been established. Often these system come from different suppliers and have different philosophies and objectives. These legacy systems are slow performing, and lack integration with each other. This results in insufficient coherence and other difficulties that interfere with efficient operations of an airline. For example it may take an airline up to 10 weeks to produce a schedule plan (the blueprint for operating the airline).

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one example embodiment of the disclosure, a system for providing air transportation services using an integrated platform includes an irregular operations (IROPs) platform configured to manage operations associated with irregular operating conditions, an operations platform configured to manage operations associated with standard operations conditions, a planning platform configured to generate one or more of the following: a fleet schedule, a maintenance schedule, a crew roster, and a financial model. The system can further include a data and cloud services platform configured to provide market data and a professional services platform configured to provide management and consulting services. The IROPs platform, the operations platform, the planning platform, the data and services platform, and the professional services platform can be integrated into an airline infrastructure.

According to another example embodiment of the disclosure, a computer-implemented method for providing air transportation services using an integrated platform includes providing at least an IROPs platform, an operations platform, a planning platform, a revenue management platform, a data and cloud services platform, and a professional services platform. The computer-implemented method can also include integrating the IROPs platform, the operations platform, the planning platform, the data and services platform, and the professional services platform into an airline infrastructure as an integrated platform.

Additionally, an integrated platform can include an IROPs platform configured to manage operations associated with irregular operating conditions, an operations platform configured to manage operations associated with standard operations conditions, and a planning platform configured to generate one or more of the following: a fleet schedule, a maintenance schedule, a crew roster, and a financial model. Further provided is a professional services platform configured to provide management and consulting services and a data and cloud services platform configured to provide market data to the platform, the operations platform, the planning platform, and the professional services platform, where the integrated platform supports one or more airlines.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings.

FIG. 1 illustrates an environment within which the methods and systems for providing air transportation services using an integrated platform can be implemented.

FIG. 2 shows a block diagram of a system for providing air transportation services using an integrated platform.

FIG. 3 is a process flow diagram showing a method for providing air transportation services using an integrated platform.

FIG. 4 is a block diagram illustrating modules and functions of an integrated platform.

FIG. 5 shows physical architecture of an integrated platform for air transportation.

FIG. 6 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

Airlines operate in a complex stochastic system in which analytic tractability is difficult. Airline operations are based on a schedule plan. The schedule plan can undergo rapid and unforeseen changes with great frequency due to the impact of operational challenges such as, for example, weather. The building of a schedule plan can in itself be a long and arduous set of tasks for the airline. This, conventionally, has been effected through a set of sequential methods, defining markets, creating a network, finding a fleet solution for this network, creating a crew solution to fly the network, determining the revenue associated with the network, costing the network. These tasks can take many weeks to plan.

One consequence of the conventional method is that various functions within the airline have become self-contained within the organization. This mode of operations can be characterized by the lack of horizontal links between system components, information, control, and focus moving up and down. Each process can be viewed in isolation, rather than being managed together with other processes. The data to some extent becomes less and less integrated.

While conventional systems may cover the planning and creating of a schedule plan which is then put into “production” and executed, they do not cover the changes, both large and small, that impact the schedule plan during its execution. These changes can have both endogenous and exogenous determinants. They may impact any aspects of the schedule plan, from demand within markets, costs, revenues and the logistics of the network itself. Dealing with these operational impacts is no different in effect to creating a new schedule plan but in an even smaller timeframe, right up to reaccommodation of passengers in a weather event.

A sine qua non of the operational platform is its statefulness. This means that the operational platform reflects the actual state of all aspects of the airline at the time and considers both problems and solutions, over ALL functional areas of the airline. Generating a solution for a large-scale IROPs event can be beyond the capabilities of the manual methods and organizational structure of the legacy systems. One of the obstacles to generating the solution is the lack of statefulness in conventional systems. Thus, the solution offered by a conventional system may not reflect the actual state of the airline. By the time one isolated system passes its information results to another, the state can change. Therefore, it is beneficial for the operational platform to integrate all functional departments of the airline to enable the solution execution in meaningful time and to avoid going through the legacy sequential path to arrive at a solution.

The legacy sequential path itself has major issues. The output of one function in the path becomes the input to the next and there is no guarantee that this approach is either optimal, satisficing, or even result in a solution at all.

The overall result of the conventional methods is that the airlines are, from an organizational point of view, highly self-contained whereas the solution requires them to be highly integrated.

This disclosure provides a stateful, integrated platform that allows for efficient planning over any time frame and timely execution of the schedule plan and resolution of operational problems and planning issues. It also provides the ability to model a variety of solutions based on real data without impacting the operational solutions and data and then executing any of the solutions against the real system of record.

Provided are methods and systems for providing air transportation services using an integrated platform. A platform-based approach allows a service provider to increase service exposure to the market place, thus broadening the customer base and removing traditional application restrictions. There is a horizontal integration within each platform and between platforms. The services provided by an airline can be associated with the following platforms: irregular operations (IROPs) platform, operations platform, planning platform, revenue management, data and cloud services platform, and professional services. For example, in the operations platform or the IROPS platform, the schedule plan, fleet, crew, maintenance, demand, and revenue management are all integrated. Additionally, the platforms in the integrated air transportation system can be integrated vertically. Thus, the operating schedule inherits from the planning process and business framework, both in the objectives and the structure and financial aspect of the plan. This provides coherence to the planning through operating cycles of business within the airline, thereby effectively merging strategy, planning, and operations. In effect the planning process produces an executable schedule plan.

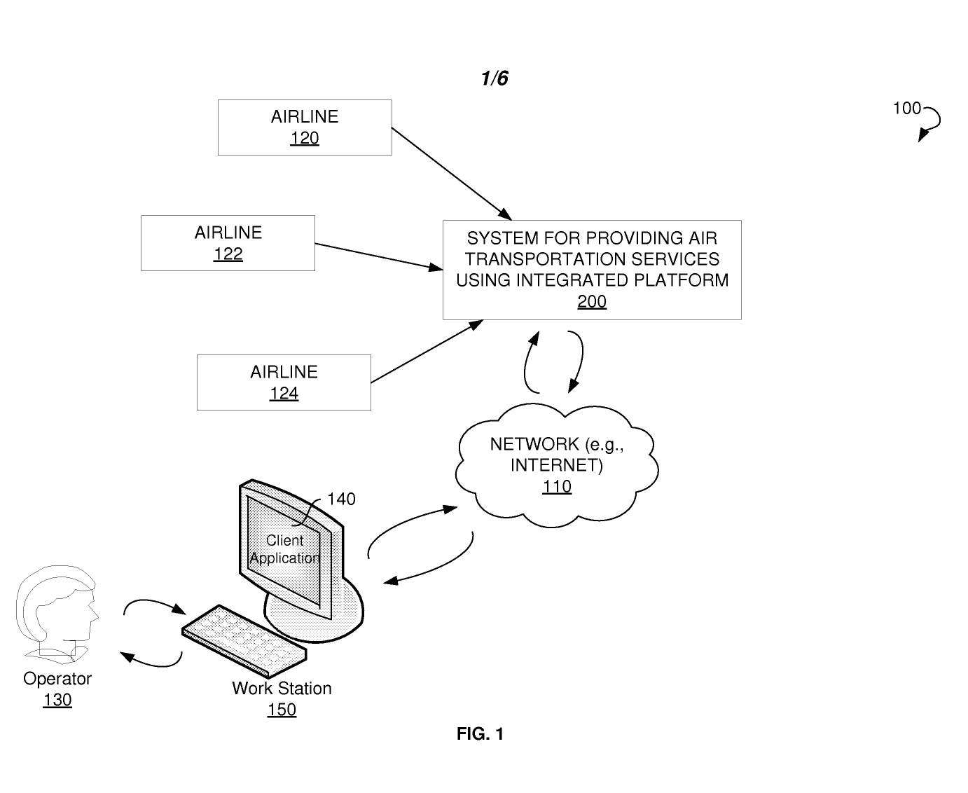

FIG. 1 illustrates an environment 100 within which the systems and methods for providing air transportation services using an integrated platform can be implemented. A system 200 for providing air transportation services using integrated platform may be associated with one or more airlines 120, 122, and 124. The airlines 120, 122, 124 can communicate with the system 200 and provide services via the system 200. The system 200 for providing air transportation services using platform can be a server-based distributed application. Thus, it may include a central component residing on a server and one or more client applications residing on work stations and communicating with the central component via a network 110.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The network 110 may include any suitable number and type of devices (e.g., routers and switches) for forwarding commands, content, and/or web object requests from each client to the online community application and responses back to the clients.

At least one operator 130 can communicate with the system 200 via a client application 140 available through a work station 150. The work station 150 may include a computer, a lap top, a smart phone, a tablet PC, and so forth. The work station 150, in some example embodiments, may include a Graphical User Interface (GUI) for displaying the user interface associated with the system 200 and the client application 140. In a typical GUI, instead of offering only text menus or requiring typed commands, the system 200 may present graphical icons, visual indicators, or special graphical elements called widgets that may be utilized to allow the operator 130 to interact with the system 200. The work station 150 may be configured to utilize icons used in conjunction with text, labels, or text navigation to fully represent the information and actions available to the operator 130.

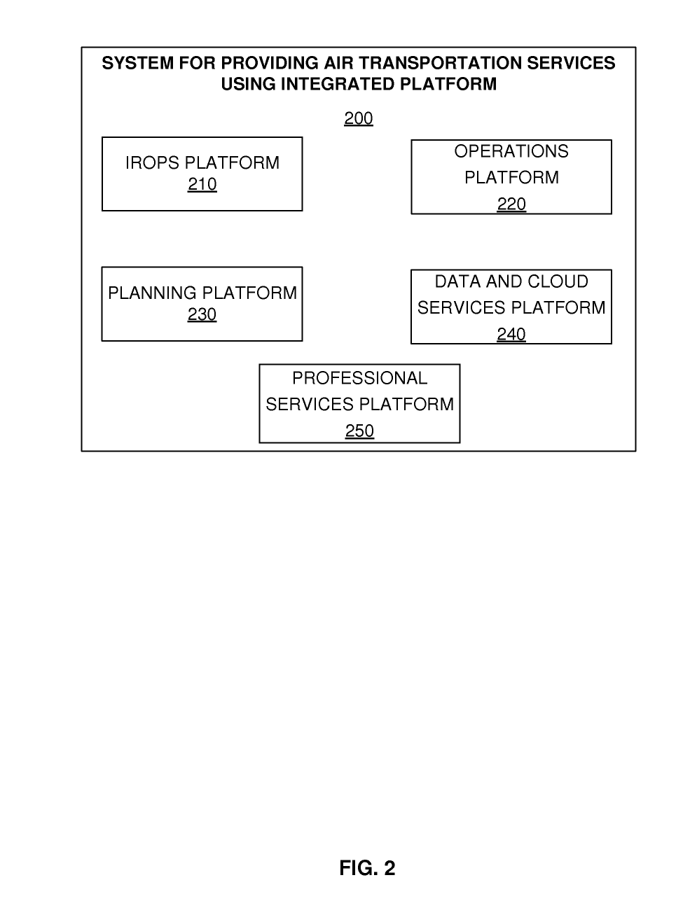

FIG. 2 shows a detailed block diagram of the system 200 for providing air transportation services using integrated platform. The system 200 may include at least the following platforms: IROPs platform 210, operations platform 220, planning platform 230, data and cloud services platform 240, and professional services platform 250. The IROPs platform 210 can be configured to manage operations associated with irregular operating conditions. The operations platform 220 can be configured to manage operations associated with standard operations conditions. The planning platform 230 can be configured to generate one or more of the following: a fleet schedule, a maintenance schedule, a crew roster, and a financial model. The data and cloud services platform 240 can be configured to provide market data. The professional services platform 250 can be configured to provide management and consulting services. The IROPs platform 210, the operations platform 220, the planning platform 230, the data and services platform 240, and the professional services platform 250 can be integrated into an airline infrastructure. Furthermore, these platforms can be fully integrated with each other both horizontally and vertically. In the integrated platform the services are additive.

With the system 200, each platform has access to all data of the system 200 for consideration. For example, when some aircraft are grounded, the schedule plan can immediately be regenerated and a new schedule plan complete with fleet, crew, cost and revenue effected as one integrated operation. In an IROP, passengers are reaccommodated instantly without having to find or load data from disparate places or silos. Revenue consideration can be taken from the revenue management system as it makes decisions to protect passengers or revenue or both.

The behavior of the system 200 is distinctly different from any other structure as is the behavior of integrated platforms in the system 200. The structure of the system 200 engenders new behavior based on integrated data and services. Due to integration, the system 200 provides statefulness, complete information, operational coherence, speed, and automation, and decision support, predictive abilities for scenarios, functional integration, organizational simplicity, and so forth.

Performance of the system 200 can be significantly higher than the performance of a conventional system. High performance in combination with functional and data integration results in the ability of the system 200 to generate the fleet schedule, the maintenance schedule, the crew roster, and/or the financial model within a practical time frame. The practical time frame can be defined as a period of time when the fleet schedule, the maintenance schedule, the crew roster, or the financial model are up to date. This means that the generated schedule or solution can be reduced to practice before it becomes outdated.

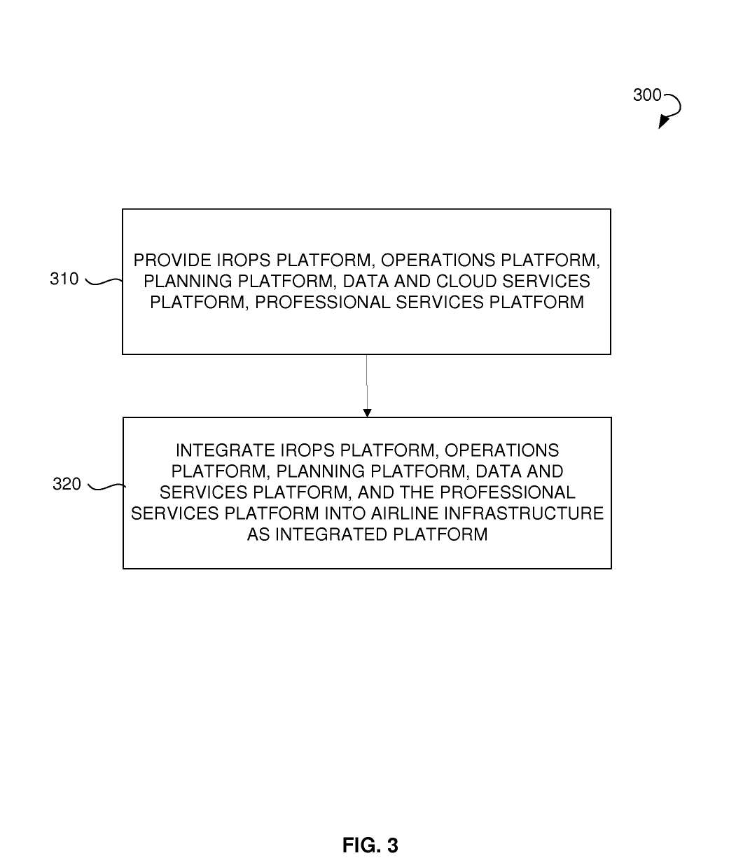

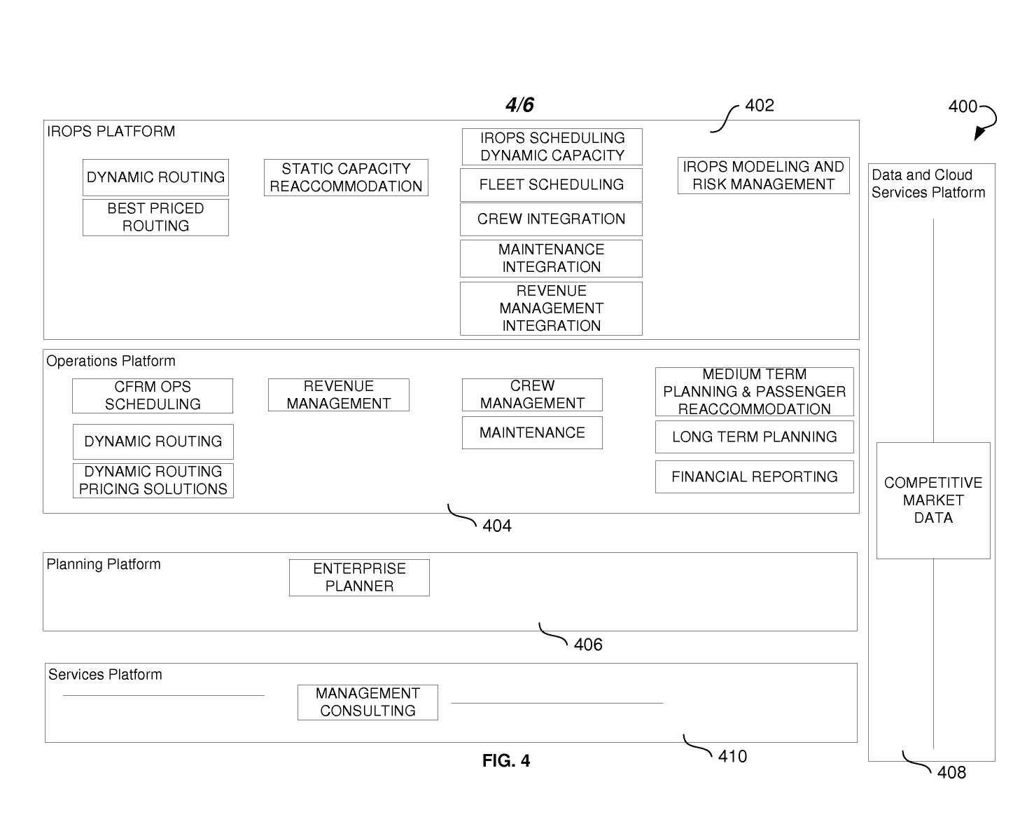

FIG. 3 is a process flow diagram showing a method 300 for providing air transportation services using an integrated platform within the environment described with reference to FIG. 1. The method 300 may commence with providing at least the IROPs platform, an operations platform, a planning platform, a data and cloud services platform, a professional services platform at operation 310. The IROPs platform, the operations platform, the planning platform, the data and services platform, and the professional services platform can be integrated into an airline infrastructure and an integrated platform at operation 320. The IROPs platform, the operations platform, the planning platform, the data and services platform, and the professional services platform can exchange data with each other directly and horizontally that provides statefulness, operational coherence, speed, automation, decision support, predictive abilities for scenarios, functional integration, and organizational simplicity. Each of the platform has access to all data in the integrated platform and results in changes to the schedule plan which reflects the impacts on all aspects of the airline operation and financial and operating factors. Thus, the integrated platform can implement functional integrations as well as data integrations. Additionally, the integrated platform can reflect real-time state of one or more airlines associated with the system 200. The platforms and their functions will now be described in detail with reference to FIG. 4.

FIG. 4 is block diagram illustrating modules and functions of an integrated platform 400.

IROPS Platform

The IROPs platform 402 can be configured to operate the airline during an IROP event. During an IROP event, the IROPs platform can subsume the operational aspects of the airline that otherwise are performed manually, partially manually, or not performed at all. The IROPs platform may comprise several modules:
Reaccommodation without schedule changes (Static Capacity Solutions);
IROP scheduling (reaccommodation with scheduling (modifying capacity dynamically). Integrated demand, fleet, crew and maintenance scheduling;
Dynamic routing that enhances network capacity;
Dynamic pricing, which together with dynamic routing services requests and bookings during an IROP (the reaccommodation engine will be in full command of the inventory, rules, and IROP);
Forward Review Model that tracks operations and automatically creates solutions.

Apart from Revenue Management, which can also be added, this represents the automation of the entire airline operations, either under normal operations or under IROP conditions.

Reaccommodation in IROPS Platform

Reaccommodation in IROPs platform 402 offers a robust and powerful reaccommodation solution that can be implemented as either a stand-alone system or as part of an integrated reservation system solution.

Reaccommodation offers an airline-centric solution which can reaccommodate passengers based on multivariate criteria, configurable policy-based criteria, and methodology, which can be distributed amongst available flight inventory by any criteria the airline chooses. This is a flexible solution that can work with airline reservation systems and fully integrates with existing airline infrastructure. Reaccommodation can be limited to passenger solutions to defined flight changes, or it can provide a series of alternate recommendations in terms of network level changes in response to larger IROP events. For example, in the event of the closure of a major hub, there may not be sufficient seats on scheduled aircraft to satisfy the residual passenger demand once flight operations resume. In this case, reaccommodation can present alternate network response models in terms of recommending changes to equipment or diverting ancillary flights to move capacity to where it is needed.

Reaccommodation is a powerful tool for high load factors airlines that are needed to quickly satisfy traveler demands. Additionally, the IROPS platform allows the airline to rank the value of their customers (configurable by the airline) and then provide comprehensive solutions in seconds.

Dynamic Reaccommodation—IROPs

Some IROP events leave an airline with major disruptions in their schedule plans. Many flights and crew can be displaced, and passenger demand builds up and cannot be satisfied within available capacity. Therefore, new and/or additional capacity needs to be generated. In this case, the airline has to create a new schedule plan in a hurry, replete with fleet, crew and maintenance, and feasible and compliant over rules of many jurisdictions.

The IROPs platform 402 offers an airline the ability to dynamically reallocate passengers, flights, and all other resources as a result of irregular operations and to whatever degree the airline requires. This process, managed at the network level, allows the airline a massive advantage in the event of weather or disruptions of any size and ensures an ongoing fully feasible schedule.

The IROPs platform 402 provides airlines with the ability to recover in an efficient manner from irregular operations events such as flight delays or cancellations that affect the “day of operations” flight schedule. The IROPs platform 402 offers operations personnel an optimum, cost-effective, and profitable path to return to the schedule in place prior to disruption. The failure to properly resolve IROPs events and manage the implementation of risk mitigated scheduling plans can have enormous implications for an airline with respect to increased contingency costs, cost overruns, and the loss of loyal passengers. The IROPs platform 402 provides a passenger, network (fleet), crew and maintenance solution to any and all irregular operations and utilizes a continuous forward review model. Therefore, as rolling waves IROPs irregularities occur, new solutions are continuously provided in near-real time for the whole network, thereby providing a key competitive advantage for the airline and allowing unequaled flexibility and control in terms of IROPs recovery. The IROPs solution is unique in a variety of aspects, including the ability to handle any size or number of irregularities, and includes a configurable and powerful workflow process to manage and track irregular operations changes and resolutions.

IROPs scheduling can automatically resolve resource allocation for crew and maintenance when information pertinent to these areas is provided. The output is a fully feasible, compliant schedule plan that merges seamlessly into the Operational Schedule Plan, thereby resolving passenger reaccommodation.

The IROPs platform 402 operates as a continuous forward review model. This means it automates solutions to IROPs of any size and frequency on a continuing basis. Workflow is provided for the airline so that the airline can make decisions as to the solution and which options and policies will be in control.

Throughout the IROPs, the system 200 maintains state with the airline, adjusting to events and decisions taken at different operational levels.

Dynamic Routing

Another problem faced by airlines is the difficulty in maintaining market records. Market records are the flight options for an Origin & Destination (O&D) that are published for sale and for which prices are set. There can be a huge number of market records, which makes maintaining them difficult and cumbersome. Prices have to be kept for different records over fare classes and service levels for each. In fact, these market records represent only a part of the network capacity for an O&D. There can be other paths for O&D in the network. Dynamic routing allows an airline to utilize these paths to generate solutions for passenger requests and to increase the capacity of the network during IROPs.

When permitted, the IROPs platform 402 can utilize network capacity of alliance carriers or third party carriers. Dynamic routing allows an airline to generate solutions dynamically without a necessity to have any market records. Restrictions, policy rules, and options can be placed on the generations of dynamic routing solutions to satisfy an airline.

In some embodiments, the restrictions and policy rules can include distance between destinations, number of stops, international restrictions (e.g., cabotage), itinerary travel time(s), itinerary interval (dates and times), network capacity (availability), cost, and so forth.

Best Priced Routing (Dynamic Routing/Dynamic Fares)

With dynamic routing, airlines can better manage passenger demand and network capacity. Best priced routing will enable airlines to sell cheaper tickets on O&D while protecting their direct (more expensive) capacity.

Dynamic routing with best priced routing enables airlines to have general pricing rules, based on demand, capacity, and utility to passengers, without having to establish and maintain millions of market records. This method can easily sit on top of the legacy systems and allow the airline to migrate from the rigid bucket pricing revenue management models that drive airline profitability down.

The sheer performance of best priced routing allows any and all queries to be dynamically priced in real time as a general service, thus avoiding the inefficiencies of the legacy distribution (GDS to Travel Agency to Client). The service can accommodate, for example, 50,000 queries per second (1.5 trillion queries a year) in a scalable architecture. Best priced routing can be offered to the entire distribution system.

Operations Platform

The operations platform 404 is similar to the IROPs platform 402 with the exception that it operates under normal rules without major disruptions.

The operations platform 404 comprises several integrated modules:
Continuous forward review model that tracks operations and automatically creates solutions;
Continuous scheduling;
Fleet, crew, and maintenance management;
Integrated revenue management;
Dynamic routing, which enhances network capacity;
Dynamic pricing, which together with dynamic routing, services all requests and bookings during an IROP (only the reaccommodation engine will be in full command of the inventory, rules, and IROPs).

Planning Platform

The planning platform 406 performs airline planning operations. Congruent planning integrates several modules and functions:
The business framework, which seeks to discover where and how the airline should compete; what the congruent fleet, crew, and infrastructure are; what the impact of crew rules is, and the like;
Creation of the Operating Schedule Plan, based on the business framework;
Management of the short term, medium term, and long term schedule plans;
Operating and financial reporting;
Risk management (in terms of the business plans).

Enterprise Planner

Conventionally, airlines are unable to plan their business in real-time against market demand, market fluctuations, competitive pressures, or cost fluctuations because of the long time period required to produce viable business plans and associated schedules. Thus, time factor prevents airlines from dealing with moving markets and demand, thereby resulting in inefficiency, lost sales, lost profits, and serious operational challenges.

The enterprise planner can solve the airline business planning problem by delivering fully viable and compliant fleet schedules, maintenance schedules, crew rosters, and financial models in minutes. This 360° view of airline planning can be accessed by multiple departments and vetted for compliance, operational validity, and financial efficiency at the time of creation, rather than weeks later.

At the center of the airline business plan is its flight schedule. Creating and maintaining the flight schedule is impacted by, and has impact on, every aspect of the airline business. Crew scheduling, maintenance scheduling, airport slotting, pricing, fleet decisions, and virtually every other aspect of operation of an airline is directly impacted by the flight schedule.

The enterprise planner can model and simulate an entire airline and its competitive environment, with the ability to generate fully compliant and feasible schedules to determine if changes to routes, fleet, crew, maintenance, or pricing policies will positively impact an airline's bottom line and competitive position. In addition to producing a schedule, the enterprise planner produces a rich set of financials with the ability to compare multiple iterations quickly to see how to drive the airline to further profitability.

The enterprise planner offers a paradigm shift in the time required to produce compliant flight schedules. In conventional systems, the time to complete a schedule plan is measured in weeks, and often extends to months, as each sub-schedule is completed independently. This process is iterated many times to achieve an operational flight schedule, which does not always achieve operational feasibility. The enterprise planner reduces this scheduling time to minutes.

The enterprise planner allows complex scenario modeling to be performed by anyone in the airline and can extend the user base beyond the planning area into the executive suite, finance, marketing, revenue management, and other departments, which significantly increases the utility to airlines.

The enterprise planner operates independently of the airline data, containing fleet configurations, route configurations, schedules, airport slots, crew, maintenance rules, and the like within itself. Additionally, it consolidates the necessary demand data to model airline performance and to deliver route analysis worldwide. This makes the enterprise planner a true stand-alone solution for airline planning and analysis.

Data and Cloud Services Platform

The data and cloud services platform 408 receives, retrieves, and provides data, such as competitive market data, to other platforms. Additionally, the data and cloud services platform 408 enables performance of operations associated with other platforms remotely over a network.

Services Platform

The services platform 410 implements management and consulting services associated with air transportation in all areas of its lifecycle. Each of the described platforms are supported by a number of highly specialized modules. One of the modules is a schedule planner.

The schedule planner enables airlines to execute and dynamically optimize their published schedules to better match ecosystem changes. Under the existing conventional approach, airlines can effectively make only minor modifications to their schedules once published. The complexities of altering the schedule with current technology and processes are prohibitive. As a result, airlines concentrate on managing revenue via changes to inventory classes and fares to address demand fluctuations and competitor dynamics.

The schedule planner offers airlines a new capability currently not available in the market. It enables airline planners to make changes to the published schedule at any point during the period of selling seats up to the day of operations, thereby providing the airline an additional control point to maximize profit. This ability, only possible with the schedule planner, offers the airline a more fluid response to unforeseen changes and breaks away from the schedule rigidity of the conventional approach.

While the strategic network plan can be developed utilizing the enterprise planner, it is the schedule planner that inherits this plan and is tasked with its execution. With present technology, this execution is extremely difficult given the multitude of variables that can cause delays or impact a schedule. The schedule planner enables the airline to solve such complexities by maintaining an integrated route, fleet, crew, and maintenance schedule, and to react to schedule impacts in minutes.

The schedule planner includes capabilities of enterprise planner with the ability to accept operational inputs at any point throughout the schedule life cycle, from the initial creation of the schedule up to and including the day of flight. This provides the airline with the ability to react to anything from a change in demand, a weather issue, a maintenance delay, or positive impacts to demand such as the temporary or permanent withdrawal of a competitor or quickly emerging new route opportunities.

Another technology supporting module is the crew planner. The crew planner produces feasible crew schedules via the integration of crew pairings and rosters in minutes. Conventional crew management systems follow a sequential, two-step process to create crew schedules that challenge the ability of airlines to deliver high-quality rosters in a short timeframe. They first generate pairings and then assign them, as well as other activities such as time off or training, to produce a roster. The breakdown of the scheduling problem into these two sub-problems leads to a less than optimal solution and is associated with manual intervention of planners to ensure that all crew scheduling requirements are satisfied.

The crew planner revolutionizes the crew scheduling process through the integration of the pairing and rostering processes. The crew planner quickly generates crew schedules that are fully supportive of the flight schedule and comply with all Federal Aviation Administration (FAA) or other regulations, labor contract work rules, seniority based bid preferences, and related airline operational policies. It produces crew schedules with lower overall costs by using a single, unified process for constructing both crew pairings and rosters. Traditional crew scheduling solutions take a stepwise, two-part, sequential approach and thus imbed limitations into the first part of the process which are then inherited by the second stage. The crew planner eliminates this inefficiency with superior problem formulation while also producing feasible solutions in far less time. The speed of producing good solutions is particularly valuable in situations that an airline operations control center typically faces when irregular operations disrupt the original crew schedule.

The crew planner is able to assist crew management across the planning and execution lifecycle. It supports key, long range planning requirements (crew base sizing, training pipeline scenarios, and so forth) through crew rostering, check-in, tracking, schedule modifications, and reporting on the day of flight operations. Key features supporting this end-to-end functionality include an integrated scheduling engine and tools for swaps and rethreads.

One more technology supporting module, revenue management (RM), manages system revenue and profitability by dynamically and adaptively setting inventory availability and fares to better match supply with demand in real-time.

Under existing revenue optimization processes, airlines manage pricing and inventory separately in their efforts to maximize revenues. While pricing analysts monitor and react to the fares of competitors, revenue analysts adjust inventory levels allocated to various fare classes. Separating these two inventories and pricing activities tends to compromise revenue performance and often leads to lower-than-expected results.

RM addresses the pressing industry need to integrate pricing and inventory decisions to maximize not only revenues but also profits. RM is an advanced system that optimizes revenues and profits by holistically integrating pricing and inventory decisions. It enables airlines to dynamically price seats based on a set of prescribed strategies at the flight, route, and region or system level. With dynamic pricing provided by RM, airlines are able to quickly respond, proactively or reactively, to competitive or other changes in the market. In addition, RM monitors profit performance against expectations and can automatically adjust market strategies, pricing, and/or inventory levels to improve results.

Once a flight schedule has been loaded into the schedule planner, RM is intended to manage system profitability by dynamically and adaptively setting inventory availability and altering fare levels so that tickets are priced to efficiently match market demand with the supply of an airline inventory of seats. The RM system has the ability in near-real time to price (and re-price) seats on each flight on each route across the entire network automatically, according to broad or individual policies, or even specific prices, in a way that no individual or group of individuals could possibly replicate or maintain manually.

A key distinction of the RM product compared to current systems is the seamless integration and operation of all of the components in the product suite to allow the holistic integration of reaccommodation, IROPs, schedule planning, crew planning, and revenue management.

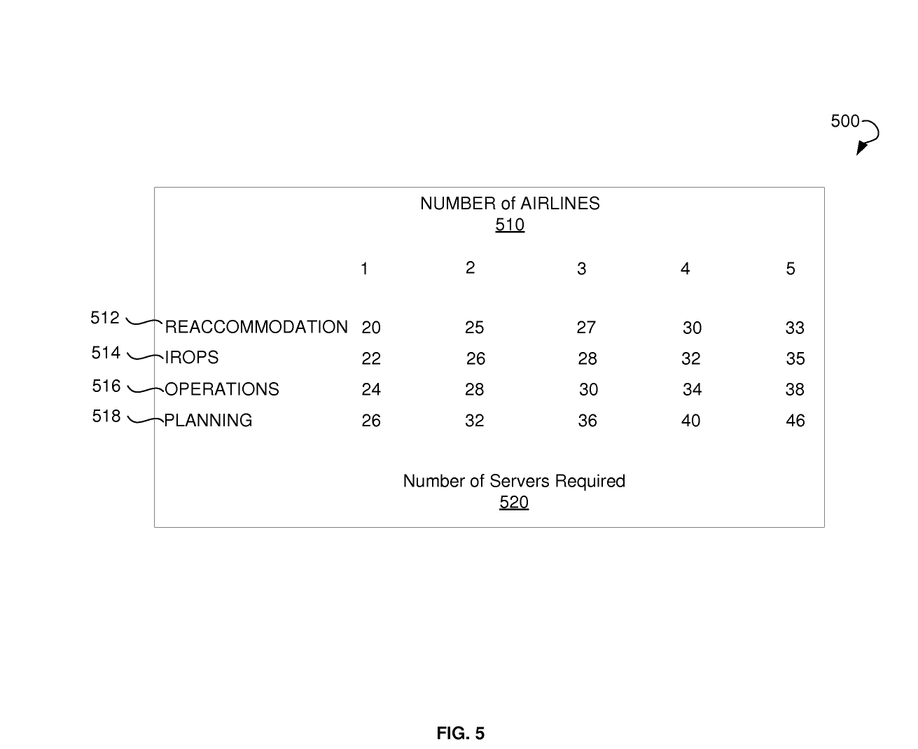

FIG. 5 shows an example physical architecture 500 of the integrated platform for providing air transportation services. The physical architecture 500 supports the integration of platforms and airlines in an efficient economic manner. The cost model for the platform expands to show the number of servers required 520 to support multiple platforms or their modules over multiple airlines of roughly equal size.

To support an airline, a reaccommodation module 512 can require, for example, 20 servers, the IROPs platform 514-22, the operations platform 516-24, the planning platform 518-26. However, to support 2 airlines, the number of servers required 520 can be significantly smaller. For example, the reaccommodation module 512 may require 25 servers, the IROPs platform 514-26, and so forth. This tendency pertains with the increase of the number of airlines 510. For example, 5 airlines may be based on 33 servers for the reaccommodation module 512, 36 for the IROPs platform 514, and so forth.

As FIG. 5 shows, the larger the number of airlines 510 and modules or platforms 512-518, the lower the unit cost of processing. The scheduling technology may be 106 times more efficient than traditional scheduling, thereby allowing for considerable savings in hardware costs. The system efficiency can be further enhanced with a proprietary memory model allowing large numbers of queries against the inventory and pricing modules.

Furthermore, the integrated platform may be uniquely architected to solve a series of crucial operational issues that an airline faces constructed on a capability maturity ladder. The operational issues and their solutions are illustrated by Table 1 below.

| | | | | Infrastructure |
|---|---|---|---|---|
| Category | Service | Problem | Description | Setup |
| Base | Stateful | Airlines do not have | | Connect |
| Platform | Services | state when processing | | “LISTENERS” |
| | | IROPS. It is desired that | | to platform |
| | | solutions are based on | | |
| | | stateful data | | |
| Special | Static | Cannot quickly find all | Reaccommodation | None |
| Service | Reaccommodation | capacity remaining and | is provided | |
| Request | Base | allocate in network | against a schedule | |
| | | prioritized manner | which has | |
| | | | cancellations | |
| | | | and delays. No | |
| | | | attempt is | |
| | | | made to provide | |
| | | | schedule solutions | |
| | Rule and Policy | Allow airline to | | None |
| | Module | dynamically configure | | |
| | | how reaccommodation | | |
| | | behaves and set policy | | |
| | | with respect to passenger, | | |
| | | logistics and revenue/cost | | |
| | Reporting | Stateful reporting to | Reporting Delegation | None |
| | Delegation | large numbers of airline | Engine handles this | |
| | | groups and passenger is | entire architecture | |
| | | difficult when information | and data integration | |
| | | not current and widely | making it available | |
| | | dispersed | on a role based model | |
| | Management | Transitioning into a | Operations Suite | None |
| | Suite | coherent organization to | | |
| | | manage is difficult on | | |
| | | top of legacy system | | |
| | Managing | Snow storm in 2 days | Allows airline to find | None |
| | Future Events | time - manner of actions | solutions for events | |
| | | | in the future and | |
| | | | begin reaccommodating | |
| | | | and redirecting demand | |
| | Suggested Delays | Unable to determine | Added ability to | NONE |
| | and Automated Crew | which flight paths to | provide schedule | |
| | Solutions for | delay for optimal | delays and additional | |
| | special request | solutions | leg segments to enhance | |
| | | | capacity and ensure | |
| | | | their operational | |
| | | | efficiency with respect | |
| | | | to crew, fleet | |
| | Suggested Added | Difficult to determine | Provides suggestions | NONE |
| | Leg Segments | where to manually place | to add leg segments | |
| | | capacity to enhance | to maximize the quality/ | |
| | | reaccommodation | quantity of the reaccom- | |
| | | solutions | modation solution | |
| | Crew Management | Takes a long time to | Add the ability to | Crew Feeds |
| | and Integration | determine feasibility for | manage crew against | |
| | | any delays or new | IROPS by keeping crew | |
| | | segments for crew, | state. Provide Crew | |
| | | maintenance, repair, | Scheduling and Rosters | |
| | | and operations (MRO) | | |
| | Fleet Management | Takes a long time to | Add the ability to | FLEET Feeds |
| | and Integration | determine feasibility for | manage fleet against | |
| | | any delays or new | IROPS by keeping | |
| | | segments for fleet MRO | fleet state and MRO | |
| | | | requirements | |
| | INTEGRATED | Necessity to quickly | | |
| | passenger | notify passenger of their | | |
| | notification | reaccommodation | | |
| | and response | options and get | | |
| | module | confirmation of their | | |
| | | acceptance/rejections. | | |
| | | This frees up inventory | | |
| | Dynamic Routing | Restrictions and | | |
| | and Associated | problem of managing | | |
| | Fares | market records | | |
| | Itinerary Reshop - | Airline cannot assume | | |
| | Interactive with | decision making for | | |
| | passenger | passenger in IROPS. | | |
| | | Requires to involve | | |
| | | passenger | | |
| | Reservation | Reservation system is | | |
| | system calls | not system of record | | |
| | to Dynamic | during IROPS | | |
| | Source Routing | | | |
| | (DSR) Engine for | | | |
| | Synchronization | | | |
| | with IROPS | | | |
| | solutions | | | |
| | SIMULATION Module | Ability to simulate, | | |
| | | events to study their | | |
| | | behavior | | |
| Schedule | When changes are | | | |
| Plan Change | made to a schedule | | | |
| Reaccommodation | plan, the passenger | | | |
| | already booked on | | | |
| | future flights need | | | |
| | to be reaccommodated | | | |
| DSR Phase | DSR for cancelled | Solutions re-integrate | | |
| ONE - Minimal | and delayed flights | cancelled flights into the | | |
| Schedule Impact | | airline schedule plan | | |
| DSR Phase | The Schedule is | | | |
| TWO - passenger | reworked to provide | | | |
| Solution and | maximum passenger | | | |
| Revenue Optimized | demand solutions | | | |
| | before is converges | | | |
| | to “normal” schedule | | | |
| DSR Phase | Revenue calculations | | | |
| THREE - passenger | are factored into | | | |
| solution optimized | the solution for | | | |
| | optimal passenger | | | |
| | and revenue based | | | |
| | schedule | | | |
| | DSR Management | | | |
| | Suite | | | |
| | Reservation | Reservation system is | Synchronization of | |
| | system calls to | not system of record | IROPS solution with | |
| | DSR Engine for | during IROPS | reservation system | |
| | synchronization | | requires all calls | |
| | with IROPS | | for inventory are | |
| | solutions | | approved by IROPS | |
| | | | Engine when solutions | |
| | | | pending | |
| | Enterprise | Enterprise Planner can | Using Enterprise | |
| | planner for | be introduced as a | planner with | |
| | DSR | method to structure the | simulation module | |
| | | scheduling and logistics | to plan more robust | |
| | | for IROPS | schedules for IROPS | |
| Data | Competitive | Proprietary market data | | |
| Services | market data | for planning and | | |
| Module | | revenue management | | |
| Enterprise | Base Planning | Integrated on top of ST | | |
| Planner | Platform | Platform | | |
| | Planning Pack One | Covers Tops in Schedule | | |
| | | “A” | | |
| | Planning Pack Two | Covers Tops in Schedule | | |
| | | “B” | | |
| | Planning Pack Three | Covers Tops in Schedule | | |
| | | “C” | | |
| | Planning Pack Four | Covers Tops in Schedule | | |
| | | “D” | | |
| Training | Online Training | | | |
| | Pack/Lecture Two | | | |
| | Online Training | | | |
| | Pack/Lecture Three | | | |
| | Online Training | | | |
| | Pack/Lecture Four | | | |

Additionally, the integrated platform can be managed and visualized by a congruent organizational structure. The organizational structure can provide the ability to view the entire integrated operation from the perspective of the schedule plan as a whole, or the individual functional areas in particular. This can create a new efficiency and experience for the airline both in operating the schedule plan and communications between the functional areas.

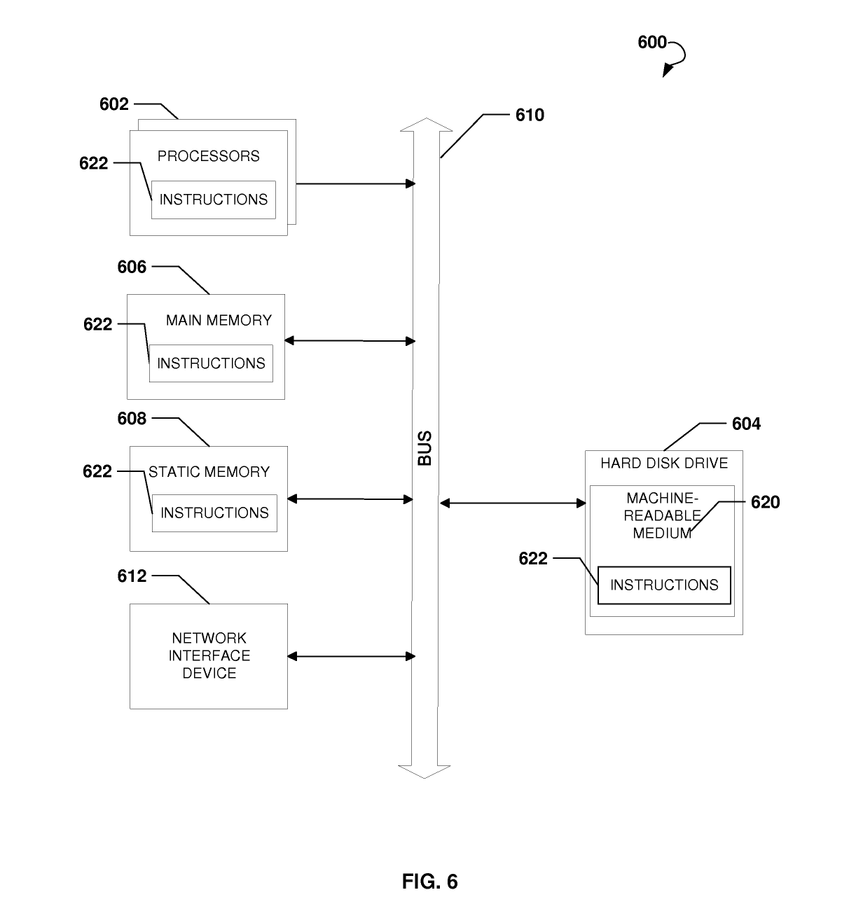

FIG. 6 shows a diagrammatic representation of a machine in the example electronic form of a computer system 600, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602, a hard disk drive 604, a main memory 606, and a static memory 608, which communicate with each other via a bus 610. The hard disk drive 604 may include a machine-readable medium 620, which stores one or more sets of instructions 622 embodying or utilized by any one or more of the methodologies or functions described herein. The instructions 622 can also reside, completely or at least partially, within the main memory 606 and/or within the processors 602 during execution thereof by the computer system 600. The main memory 606 and the processors 602 also constitute machine-readable media.

The instructions 622 may further be transmitted or received over a network 626 via a network interface device 612 utilizing any one of a number of well-known transfer protocols (e.g., Hyper Text Transfer Protocol (HTTP)).

In some embodiments, the computer system 600 may be implemented as a cloud-based computing environment, such as a virtual machine operating within a computing cloud. In other embodiments, the computer system 600 may itself include a cloud-based computing environment, where the functionalities of the computer system 600 are executed in a distributed fashion. Thus, the computer system 600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as the work station 150, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present technology has been presented for purposes of illustration and description, but is not intended to be exhaustive or limited to the disclosure. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

Aspects of the present technology are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, computer-implemented methods and systems for providing air transportation services using an integrated platform are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

1. A system for providing air transportation services using an integrated platform, the system comprising:
an irregular operations (IROPs) platform configured to manage operations associated with irregular operating conditions;
an operations platform configured to manage operations associated with standard operations conditions;
a planning platform configured to generate one or more of the following: a fleet schedule, a maintenance schedule, a crew roster, and a financial model;
a data and cloud services platform configured to provide market data; and
a professional services platform configured to provide management and consulting services, wherein the IROPs platform, the operations platform, the planning platform, the data and services platform, and the professional services platform are integrated into an airline infrastructure as an integrated platform.

2. The system of claim 1, wherein the integrated platform supports multiple airlines in providing air transportation services.

3. The system of claim 1, wherein each of the IROPs platform, the operations platform, the planning platform, the data and services platform, and the professional services platform have access to all data associated with the integrated platform.

4. The system of claim 1, wherein the integrated platform reflects real-time state of one or more airlines associated with the system.

5. The system of claim 1, wherein the IROPs platform, the operations platform, the planning platform, the data and services platform, and the professional services platform interact with each other horizontally.

6. The system of claim 1, wherein the integrated platform models one or more operational solutions based on real data without impacting operational data.

7. The system of claim 6, wherein the one or more operational solutions are executed against a real system of record.

8. A computer-implemented method for providing air transportation services using an integrated platform, the method comprising:
providing at least an IROPs platform, an operations platform, a planning platform, a data and cloud services platform, a professional services platform; and
integrating the IROPs platform, the operations platform, the planning platform, the data and services platform, and the professional services platform into an airline infrastructure as an integrated platform.

9. The method of claim 8, further comprising managing, by the IROPs platform, operations associated with irregular operating conditions.

10. The method of claim 8, further comprising managing, by the operations platform, operations associated with standard operations conditions.

11. The method of claim 8, further comprising generating, by the planning platform, one or more of the following: a fleet schedule, a maintenance schedule, a crew roster, and a financial model.

12. The method of claim 8, further comprising providing market data by the data and cloud services platform.

13. The method of claim 8, further comprising providing management and consulting services by the professional services platform.

14. The method of claim 8, further comprising modelling one or more operational solutions based on real data without impacting operational data.

15. The method of claim 8, wherein the IROPs platform, the operations platform, the planning platform, the data and services platform, and the professional services platform interact with each other horizontally.

16. The method of claim 8, wherein the integrated platform supports multiple airlines.

17. An integrated platform comprising:
an IROPs platform configured to manage operations associated with irregular operating conditions;
an operations platform configured to manage operations associated with standard operations conditions;
a planning platform configured to generate one or more of the following: a fleet schedule, a maintenance schedule, a crew roster, and a financial model;
a professional services platform configured to provide management and consulting services; and
a data and cloud services platform configured to provide market data to the platform, the operations platform, the planning platform, and the professional services platform, wherein the integrated platform supports one or more airlines.

18. The integrated platform of claim 17, wherein each of the IROPs platform, the operations platform, the planning platform, the data and services platform, and the professional services platform have access to all data associated with the integrated platform.

19. The integrated platform of claim 17, wherein the IROPs platform, the operations platform, the planning platform, the data and services platform, and the professional services platform communicate with each other horizontally.

20. The integrated platform of claim 17, wherein one or more of the following is generated: the fleet schedule, the maintenance schedule, the crew roster, and the financial model, is generated in practical time frame, the practical time frame being a period of time during which the one or more of the following: the fleet schedule, the maintenance schedule, the crew roster, and the financial model, is up to date.
